(19) United States
(12) Patent Application Publication
(10) Pub. No.: US 2016/0100221 A1
(43) Pub. Date: Apr. 7, 2016

(54) SYSTEM AND METHOD FOR PREVENTING ABANDONMENT OF WEB-BASED VIDEO CONTENT

(71) Applicant: StreamRail Ltd., Tel Aviv (IL)

(72) Inventors: Or HILTCH, Rishon LeZion (IL); Guy ZIPORI, Kfar Saba (IL)

(73) Assignee: StreamRail Ltd., Tel Aviv (IL)

(21) Appl. No.: 14/876,081

(22) Filed: Oct. 6, 2015

Related U.S. Application Data
(60) Provisional application No. 62/060,044, filed on Oct. 6, 2014.

(51) Int. Cl. H04N 21/466; H04N 21/442

(52) U.S. Cl. CPC H04N 21/4667; H04N 21/44204

(57) ABSTRACT

A system and method for generating abandonment profiles for web-based video content. The method comprises: monitoring user interactions with a video content item; generating at least one abandonment metric based on the monitored user interactions, wherein each abandonment metric represents a feature associated with abandonment of the video content item; and generating an abandonment profile including the at least one abandonment metric.

### CROSS-REFERENCE TO RELATED APPLICATIONS

This application claims the benefit of U.S. Provisional Application No. 62/060,044 filed on Oct. 6, 2014, the contents of which are hereby incorporated by reference.

### TECHNICAL FIELD

The present disclosure relates generally to providing video content, and more particularly to monitoring user interactions with video content.

### BACKGROUND

Due to the abundance of video content made available through a wide variety of sources and, in particular, through the Internet, analysis of user likes and dislikes concerning video viewing experiences has become essential for businesses seeking to ensure that content reaches viewers. Such businesses may wish to ensure that, e.g., users stay throughout a video to view advertisements and/or product placement within the video, or that users have a positive experience, thereby encouraging future views.

User preferences regarding videos may vary, but typical preferences include short startup times, high bit rates, and so on. Video clips that do not meet a particular user's preferences may be abandoned by users before the video ends. Particularly for videos featuring advertisements, abandonment can lead to financial (i.e., loss of advertising revenue) and or reputational (i.e., association with viewers losing interest) losses.

Due to the inability to quickly and accurately derive video viewing preferences of a user, many video clips lack the features needed to maintain the user's interest and, as a result, may be abandoned before the user completes viewing a particular video clip. A solution capable of utilizing user profiles to prevent or reduce user abandonment of videos would therefore be desirable.

It would therefore be advantageous to provide a solution that would overcome the deficiencies of the prior art by generating abandoned profiles of users.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for generating abandonment profiles for web-based video content. The method comprises: monitoring user interactions with a video content item; generating at least one abandonment metric based on the monitored user interactions, wherein each abandonment metric represents a feature associated with abandonment of the video content item; and generating an abandonment profile including the at least one abandonment metric.

The disclosed embodiments also include a system for generating abandonment profiles for web-based video content, comprising: a processing unit; and a memory, the memory containing instructions that, when executed by the processing unit, configures the system to: monitor user interactions with a video content item; generate at least one abandonment metric based on the monitored user interactions, wherein each abandonment metric represents a feature associated with abandonment of the video content item; and generate an abandonment profile including the at least one abandonment metric.

The disclosed embodiments also include a method for reducing abandonment of web-based video content based on abandonment profiles, comprising: identifying an attempt to access a web source; retrieving an abandonment profile including at least one abandonment metric, wherein each abandonment metric represents a feature associated with abandonment of the video content item and is associated with any of: a user device attempting to access the web source, a user attempting to access the web source, and a video content item existing on the web source; and generating at least one recommendation based on the abandonment profile, wherein each recommendation indicates at least one action that will reduce the chance of premature video content abandonment.

The disclosed embodiments also include a system for reducing abandonment of web-based video content based on abandonment profiles, comprising: a processing unit; and a memory, the memory containing instructions that, when executed by the processing unit, configure the system to: identify an attempt to access a web source; retrieve an abandonment profile including at least one abandonment metric, wherein each abandonment metric represents a feature associated with abandonment of the video content item and is associated with any of: a user device attempting to access the web source, a user attempting to access the web source, and a video content item existing on the web source; and generate at least one recommendation based on the abandonment profile, wherein each recommendation indicates at least one action that will reduce the chance of premature video content abandonment.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for generating abandonment profiles respective of video content according to an embodiment.

FIG. 3 is a flowchart illustrating a method for pre-fetching and adjusting video content according to an embodiment.

FIG. 4 is a flowchart illustrating a method for providing recommendations based on user abandonment profiles according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating user abandonment profiles. A request for video content is received from a user device. The video content is retrieved and sent to the user device for display. User interactions with the video content are monitored. Based on the monitoring, at least one abandonment metric is generated for the video content. The at least one abandonment metric is used to generate an abandonment profile. Respective of the abandonment profile, a video containing the video content may be adjusted.

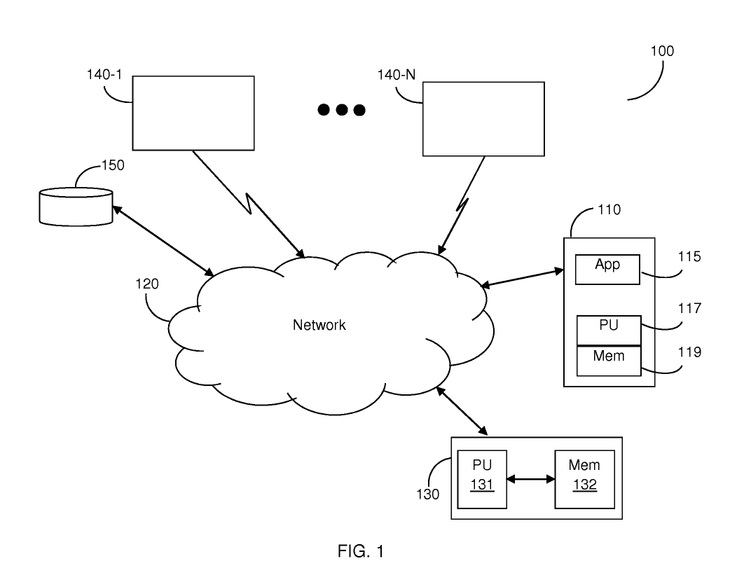

FIG. 1 shows an exemplary and non-limiting network diagram 100 utilized to describe the various disclosed embodiments. A user device 110 is communicatively connected to a network 120. The network 120 may be, but is not limited to, a wireless, cellular or wired network, a local area network (LAN), a wide area network (WAN), a metro area network (MAN), the Internet, the worldwide web (WWW), similar networks, and any combination thereof. The user device 110 may be, but is not limited to, a smart phone, a mobile phone, a laptop, a tablet computer, a wearable computing device, a personal computer (PC), a smart television, and the like. It should be noted that a single user device 110 is shown merely for simplicity purposes and without limitation on the disclosed embodiments. Multiple user devices may be communicatively connected to the network and have abandonment profiles generated or utilized respective thereto without departing from the scope of the disclosed embodiments.

In an embodiment, the user device 110 includes an agent 115 installed therein. The agent 115 may be a software code that is installed in a memory (not shown) of the user device 110 and executed by a processing unit (not shown) of the user device 110.

Also connected to the network 120 are a server 130, a plurality of web sources 140-1 through 140-N (hereinafter referred to collectively as web sources 140 or individually as a web source 140, merely for simplicity purposes), and a database 150. The web sources 140 may be, but are not limited to, web-pages, remote servers, data centers, content delivery networks (CDNs), other user devices, combinations thereof, and so on. The request contains information at least respective of the web source 140.

The user device 110 and/or the agent 115 are communicatively connected to the server 130 via the network 120. According to the disclosed embodiments, the server 130 is configured to cause the user device 110 and/or the agent 115 to optimize the delivery of video content to the user device 110 as described further herein below. To this end, the server 130 is configured to receive a request for at least one video content item residing in at least one web source 140. Based on the request, the server 130 may identify an optimal web source such as, e.g., the web source 140-1, for providing the video content item therefrom. The identification may be based on a pointer included in the request. A pointer may be, but is not limited to, a URL, a URI, a content item ID, a combination thereof, and so on. Identification of an optimal web source may further include determining, based on the request, a plurality of nodes that previously requested the video content item from the identified web source and selecting one of the nodes to provide the video content item based on, e.g., current availability, location with respect to the first node, bandwidth, and so on. Identifying optimal web sources is described further in U.S. patent application Ser. No. 14/796,293 filed on Jul. 10, 2015, assigned to the common assignee, the contents of which are hereby incorporated by reference.

In an embodiment, the server 130 is configured to fetch the requested video content item from the identified optimal web source. In a further embodiment, the video content item can be fetched using a web real-time communication (webRTC) application programming interface (API). In a further embodiment, the content item may be fetched by an RTCDataChannel API. In such an embodiment, the server 130 is configured to establish a channel to the optimal web source and to configure data transport settings.

The server 130 is configured to send the retrieved video content item for display on the user device 110. According to another embodiment, the server 130 is configured to inspect video content displayed on or provided to the user device 110 in order to determinate the user preferences. It should be noted that the server 130 can also inspect the video content items that were not fetched by the server.

The server 130 is configured to continuously monitor interactions by a user of the user device 110 with the video content item. In an embodiment, the server 130 may be configured to cause the monitoring of the interactions by the agent 115 installed on the user device 110. The monitoring may include identifying abandonment metrics such as, but not limited to, video content metrics associated with the video content and personal metrics associated with the user device 110 and/or the user thereof. The monitoring may further include gathering data for each metric. Such gathered data may be, but is not limited to, a number of rebuffering events, a load time (i.e., the time between requesting the video content item and viewing the video content item), a bit rate, a time in the video (e.g., 30 seconds into the video, 5 minutes into the video, etc.), and so on. The abandonment metrics may include, but are not limited to, features of the video content item that may have contributed to the abandonment. Features that may contribute to abandonment may be predetermined, or may be identified based on comparison with data gathered respective of other video content items that were abandoned during viewing.

Video content metrics may include, but are not limited to, a start-time of the video content item, an end time of the video content item, rebuffering occurrence(s), bit rate metadata, frame changes, and more. User metrics may include, but are not limited to, any action requested by the user with respect to the video content item (e.g., stopping the video content item, pausing the video content item, changing the screen size, changing the resolution, leaving the video content item (e.g., by navigating to a different page or by selecting a different video content item), and so on. User device metrics may include configuration(s) of the user device 110, a type of the user device 110, an operating system of the user device 110, and so on.

According to one embodiment, the server 130 is configured to compute a score for each metric. Each metric score is a value assigned to one of the metrics. In an embodiment, the metric scores may be utilized in a prediction model to determine a likelihood of abandonment based on values of the metrics identified during viewing. When the metrics are applied to the model, a prediction of a likelihood of abandonment may be determined. As a non-limiting example, a prediction model may be a function with coefficients equal to the metric scores. When values respective of the metrics are applied to the function, a predicted likelihood of abandonment may be computed.

The metric scores represent the correlation between each metric and premature video content abandonment (i.e., abandonment of video content items before viewing is complete). The metric scores may be based on information such as, but not limited to, a number of users who abandoned the video content item during viewing, a proportion of users who abandoned the video content item during viewing, times at which users abandoned the video content item during viewing, and so on.

As a non-limiting example for generating a metric score, a metric related to the number of rebuffering instances occurring during display of a video content item is identified. In this example, the metric scores range from 1 (little or no abandonment) to 10 (high abandonment rates). Based on a comparison to other video content items that were abandoned during viewing, it is determined that there is a high positive correlation between the number of rebuffering instances and the rates of abandonment of video content items. Accordingly, a metric score of 9 may be generated for video content items in which 3 or more instances of rebuffering occurred.

Respective of each metric and its respective score, the server 130 generates an abandonment profile associated with the interaction of the user device 110 with the video content item. The abandonment profile represents user tendencies for abandoning videos in response to various metrics. For example, the abandonment profile may indicate that users of a particular device type frequently abandon videos that have low frame rates. As another example, the abandonment profile may indicate that viewers of a particular video content item frequently abandon the video content item after pausing the video content item when there is a long initial buffering. The server 130 is configured to send the abandonment profile for storage in the database 150 in association with the user device 110 and/or in association with the video content item.

Upon receiving a request for the video content item and/or a request for another video content item from the user device 110, the server 130 is configured to obtain the abandonment profile associated with a user of the device 110 from the database 150. Alternatively, the abandonment profile may be obtained from a local storage unit (not shown) of the user device 110. Thereafter, the server 130 is configured to adjust the requested video content respective of the abandonment profile. Adjustment of the requested video content is performed in order to provide a suitable viewing experience as derived from the abandonment profile. In an embodiment, the video adjustment may include, but is not limited to, reallocating resources to ensure that user preferences are met, pre-retrieving the video content item (i.e., retrieving the entire video content item prior to display), and so on.

As a non-limiting example, if the abandonment profile indicates that similar users abandon videos with low bit rates, the server 130 may perform extended pre-caching of the video content, thereby allocating more resources and time to increasing the bit rate during viewing.

In an embodiment, an optimal web source of the plurality of web sources 140 may be selected to handle the delivery of the video content item. In a further embodiment, the selection of an optimal web source of the plurality of web sources 140 to handle the delivery of the video content item may further be made respective of the user abandonment profile. As a non-limiting example, if the user abandonment profile indicates that the user tends to abandon the video content item if it is streamed at a low bit rate, an alternate or optimal web source that is geographically located closest to the user device may be selected as the optimal web source. Various techniques for optimizing the delivery of video content are discussed in the above-referenced U.S. patent application Ser. No. 14/796,293.

In certain configurations, the server 130 includes a processing unit 132 and a memory 134. The processing unit 132 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may be coupled to the memory 134. In an embodiment, the memory 134 contains instructions that when executed by the processing unit results in the performance of the methods and processes described herein below. Specifically, the memory 134 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 132 to perform the various functions described herein.

It should be noted that the user device 110 includes a processing unit and a memory (not shown) having the structure and functionality those described herein above.

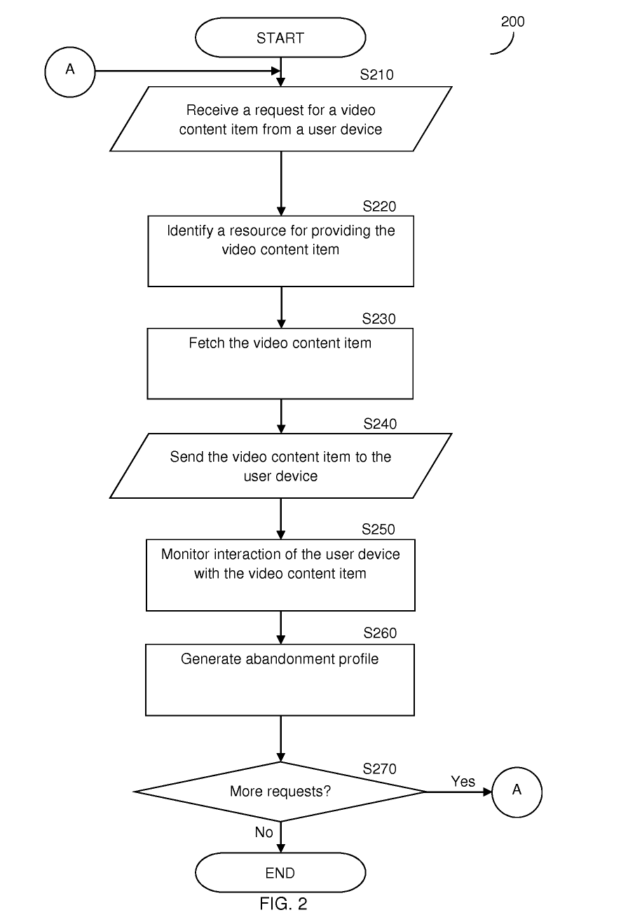

FIG. 2 is an exemplary and non-limiting flowchart 200 illustrating a method for generating an abandonment profile respective of video content according to an embodiment. In an embodiment, the steps of flowchart 200 may be performed by a server (e.g., the server 130). In another embodiment, the steps of flowchart 200 may be performed by an agent (e.g., the agent 115) installed on a client device (e.g., the user device 110) that is configured by a server (e.g., the server 130). In S210, a request for a video content item residing in at least one web source (e.g., the web source 140) is received from a user device (e.g., the user device 110). In an embodiment, the request may be received from an agent (e.g., the agent 115) installed on the user device. In a further embodiment, the request may be intercepted by the agent and forwarded to the server.

In S220, at least one optimal web source for providing the video content item (e.g., the web source 140-1), is identified. Identification of optimal web sources is described further herein above with respect to FIG. 1. In S230, the video content item is fetched from the optimal web source.

In S240, the video content item is streamed for display on the user device. In S250, the interactions of a user of the user device with the video content item are monitored. The monitoring includes identifying user abandonment metrics as described further herein above with respect to FIG. 1. To this end, the monitoring may further include, but is not limited to, determining whether the user device abandoned the video (by, e.g., navigating to another page, canceling a stream, stopping the video, blocking the content, etc.), determining how long the user device displayed the video before abandonment, and so on.

In S255, a metric score is computed for each identified metric. The metric scores represent the correlations between each metric and premature video content abandonment (i.e., abandonment of video content items before viewing is complete). The metric scores may indicate information such as, but not limited to, a number of users who abandoned the video content item during viewing, a proportion of users who abandoned the video content item during viewing, times at which users abandoned the video content item during viewing, and so on. Computation of metric scores for identified metrics is described further herein above with respect to FIG. 1.

In S260, an abandonment profile is generated respective of a user of the user device, the user device, and/or the video content item based on the monitored interactions. In S270, it is checked whether there are additional requests and if so, execution continues with S210; otherwise, execution terminates.

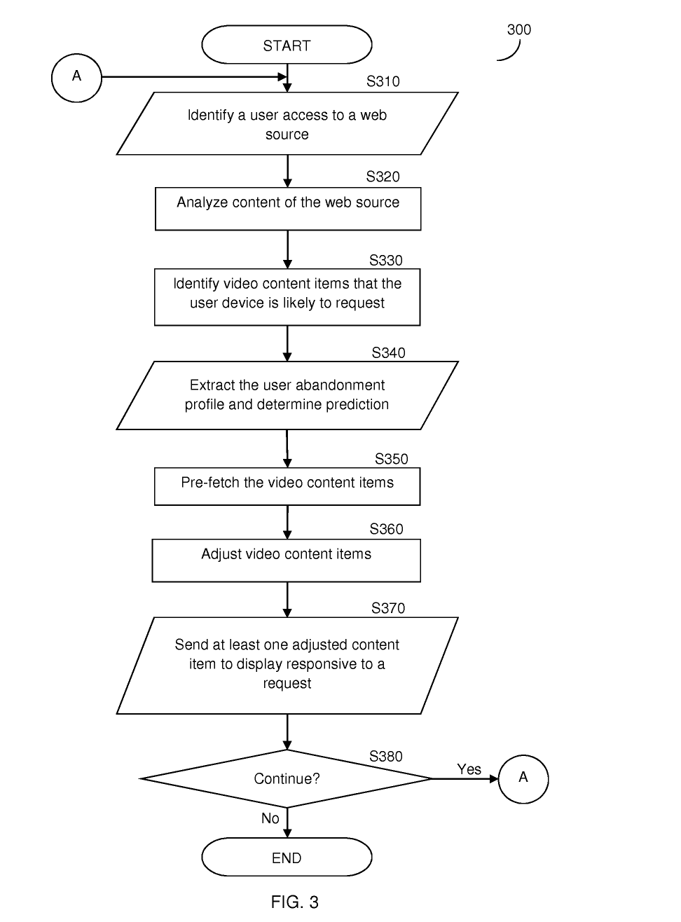

FIG. 3 is an exemplary and non-limiting flowchart 300 illustrating a method for pre-retrieving and adjusting video content based on user abandonment profiles in accordance with an embodiment. In S310, an attempt by a user device to access at least one web source from a plurality of web sources (e.g., the web sources 140) is intercepted. In S320, the content existing on the web source is analyzed. The analysis may include, but is not limited to, identifying video content items existing on the web source.

In S330, respective of the analysis, at least one video content item residing in the web source likely to be requested by the user is identified. The identification may be based on user experience and/or based on experiences of similar user devices. In an embodiment, the identified at least one video content item may include, for example, all video content items displayed on a “home” page displayed on a web site hosted on the web source. For example, the at least one video content item may include each video currently being displayed on the home page of Youtube®.

In S340, a likelihood of abandonment is determined respective of a user abandonment profile. In an embodiment, the user abandonment profile may be extracted from a database (e.g., the database 160). The user abandonment profile identifies one or more tendencies of the user with respect to certain experiences. In an embodiment, the user abandonment profile may be a prediction model (e.g., a prediction function) used to predict a chance of abandonment based on various parameters. The prediction model may be based on metric scores assigned to metrics of video content items. As a non-limiting example, a prediction model may be a function with coefficients equal to the metric scores. When values of the metrics are applied to the prediction model, a prediction of a likelihood of abandonment may be determined.

In S350, the identified at least one video content item is retrieved. In an embodiment, it may be determined whether the at least one video content item should be pre-retrieved (i.e., retrieved prior to the beginning of display of the at least one video content item). The determination may be based on the extracted user abandonment profile. In other words, if the user abandonment profile indicates that pre-retrieving the content will provide an experience that will reduce the likelihood that the video will be abandoned during viewing, the video content item may be pre-retrieved.

In S360, respective of the user abandonment profile, the at least one video content item is adjusted. The adjustment is performed so as to reduce the chance of user abandonment of the video. For example, the user abandonment profile indicates that a user viewing a particular video content item tends to abandon the video if the user is presented with a long wait time before beginning. Accordingly, the initial buffering time of the video may be decreased (which may be lead to subsequent reductions in performance) so as to ensure that the user can begin viewing the video content item more quickly. In an embodiment, the video content item is adjusted only if the likelihood of abandonment is above a predefined threshold.

In S370, in response to a request for a video content item from the user device, the at least one adjusted video content item is sent to the user device. In S380, it is checked whether additional access attempts have been identified and, if so, execution continues with S310; otherwise, execution terminates.

It should be noted that the method for generating abandonment profiles as described in FIG. 2 and the method for pre-fetching and adjusting video content as described in FIG. 3 may be integrated without departing from the scope of the disclosed embodiments.

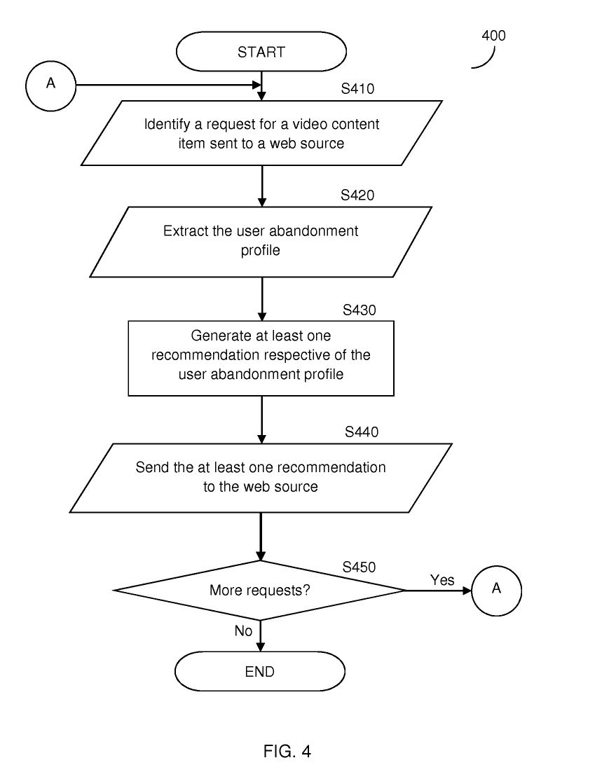

FIG. 4 is an exemplary and non-limiting flowchart 400 illustrating a method for generating recommendations for reducing user abandonment rate of video content items respective of a user abandonment profile in accordance with an embodiment. In S410, a request from the user device for at least one video content item sent to at least one web source is identified. In S420, a user abandonment profile is extracted from, for example, a database (e.g., the database 150). The user abandonment profile may be associated with at least one of: the user device, a user of the user device, and the requested video content item.

In S430, at least one recommendation is generated based on the at least one user abandonment profile. Each recommendation may be, but is not limited to, a suggestion with regard to retrieving the video (e.g., a suggestion to pre-retrieve video content, a web source from which to retrieve the video content item, etc.), a suggested adjustment to the video, and so on. Generating the at least one recommendation may include, but is not limited to, analyzing the user abandonment profile to identify features that are associated with user abandonment and determining an action (e.g., pre-retrieving the video or adjusting the video) that would mitigate such features.

In an embodiment, analyzing the user abandonment profile may further include analyzing a prediction model to identify a parameter that increases the likelihood of abandonment and a parameter that decreases or does not substantially affect the likelihood of abandonment. As a non-limiting example, numerous instances of rebuffering may be associated with a high likelihood of abandonment, while slightly longer initial loading times are not associated with increased abandonment rates. Thus, if the abandonment profile indicates that the user tends to abandon video content upon rebuffering, the recommendation may be to pre-retrieve the video content (thereby extending the initial loading time) in order to decrease the chance of rebuffering and, therefore, decrease the chance that the user will abandon the video during viewing.

In S440, the at least one recommendation is sent to the web source. In S450, it is checked whether additional requests have been received and, if so, execution continues with S410; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating abandonment profiles for web-based video content, comprising:
monitoring user interactions with a video content item;
generating at least one abandonment metric based on the monitored user interactions, wherein each abandonment metric represents a feature associated with abandonment of the video content item; and
generating an abandonment profile including the at least one abandonment metric.

2. The method of claim 1, further comprising:
identifying a request for the video content item;
retrieving the video content item; and
causing a display of the video content item on a user device.

3. The method of claim 1, wherein each abandonment metric is any of: a metric associated with the video content item, a metric associated with a user device, and a metric associated with a user.

4. The method of claim 1, further comprising:
generating a metric score for each abandonment metric, wherein each metric score represents a correlation between the respective abandonment metric and premature abandonment of videos.

5. A non-transitory computer readable medium having stored thereon instructions for causing one or more processing units to execute the method according to claim 1.

6. A system for generating abandonment profiles for web-based video content, comprising:
a processing unit; and
a memory, the memory containing instructions that, when executed by the processing unit, configures the system to:
monitor user interactions with a video content item;
generate at least one abandonment metric based on the monitored user interactions, wherein each abandonment metric represents a feature associated with abandonment of the video content item; and
generate an abandonment profile including the at least one abandonment metric.

7. The system of claim 6, wherein the system is further configured to:
identify a request for the video content item;
retrieve the video content item; and
cause a display of the video content item on a user device.

8. The system of claim 6, wherein each abandonment metric is any of: a metric associated with the video content item, a metric associated with a user device, and a metric associated with a user.

9. The system of claim 6, wherein the system is further configured to:
generate a metric score for each abandonment metric, wherein each metric score represents a correlation between the respective abandonment metric and premature abandonment of videos.

10. A method for reducing abandonment of web-based video content based on abandonment profiles, comprising:
identifying an attempt to access a web source;
retrieving an abandonment profile including at least one abandonment metric, wherein each abandonment metric represents a feature associated with abandonment of the video content item and is associated with any of: a user device attempting to access the web source, a user attempting to access the web source, and a video content item existing on the web source; and
generating at least one recommendation based on the abandonment profile, wherein each recommendation indicates at least one action that will reduce the chance of premature video content abandonment.

11. The method of claim 10, wherein the at least one action includes any of: pre-retrieving at least one video content item, and adjusting the video content item.

12. The method of claim 11, further comprising:
performing each recommended action.

13. The method of claim 12, wherein pre-retrieving at least one video content item further comprises:
identifying at least one video content item likely to be requested.

14. The method of claim 10, wherein generating at least one recommendation based on the abandonment profile further comprises:
analyzing the abandonment profile to identify at least one feature associated with abandonment of video content items; and
determining, based on the identified at least one feature, at least one action that would mitigate the at least one feature.

15. A non-transitory computer readable medium having stored thereon instructions for causing one or more processing units to execute the method according to claim 1.

16. A system for reducing abandonment of web-based video content based on abandonment profiles, comprising:
a processing unit; and
a memory, the memory containing instructions that, when executed by the processing unit, configure the system to:
identify an attempt to access a web source;
retrieve an abandonment profile including at least one abandonment metric, wherein each abandonment metric represents a feature associated with abandonment of the video content item and is associated with any of: a user device attempting to access the web source, a user attempting to access the web source, and a video content item existing on the web source; and
generate at least one recommendation based on the abandonment profile, wherein each recommendation indicates at least one action that will reduce the chance of premature video content abandonment.

17. The system of claim 16, wherein the at least one action includes any of: pre-retrieving at least one video content item, and adjusting the video content item.

18. The system of claim 17, wherein the system is further configured to:
perform each recommended action.

19. The system of claim 18, wherein the system is further configured to:
identify at least one video content item likely to be requested.

20. The system of claim 16, wherein the system is further configured to:
analyze the abandonment profile to identify at least one feature associated with abandonment of video content items; and
determine, based on the identified at least one feature, at least one action that would mitigate the at least one feature.
